(19) United States
(12) Patent Application Publication
(10) Pub. No.: US 2010/0206348 A1
(43) Pub. Date: Aug. 19, 2010

(54) Crutch

(76) Inventor: Demetrios Markou, Lemont, IL (US)

Correspondence Address: LITMAN LAW OFFICES, LTD., POST OFFICE BOX 41200, SOUTH STATION, ARLINGTON, VA, 22204, US

(21) Appl. No.: 12/591,451

(22) Filed: Nov. 19, 2009

Related U.S. Application Data
(60) Provisional application No. 61/202,286, filed on Feb. 13, 2009.

(51) Int. Cl. A61H 3/02

(52) U.S. Cl. 135/71; 135/68

(57) ABSTRACT

The crutch includes a lower pole with a handgrip near the upper end thereof, and may include a forearm cuff above the handgrip in the case of a forearm type crutch. The distance between cuff and handgrip is adjustable, as is the lower pole length. A resilient limb or bow is rigidly affixed to the lower end of the pole, with its upper attachment end being rearwardly offset from the pole. This results in a forward torque or moment when the user applies a downward force upon the crutch during use, thereby assisting the user in forward travel. The lower or distal end of the limb also absorbs shock for the crutch user when the limb contacts the underlying surface. The springback of the limb returns a considerable portion of the energy imparted by the user as weight was applied to the crutch, thereby facilitating user mobility.

### CROSS-REFERENCE TO RELATED APPLICATION

This application claims the benefit of U.S. Provisional Patent Application Ser. No. 61/202,286, filed Feb. 13, 2009.

### BACKGROUND OF THE INVENTION

1. Field of the Invention

The present invention relates generally to mobility aids for the physically handicapped, and particularly to a cane or crutch, e.g., a forearm crutch, having a resilient bow or limb extending from the lower end of the crutch pole, providing resilience and energy recovery for the user.

2. Description of the Related Art

Innumerable devices have been developed in the past to provide or facilitate mobility for the physically handicapped. While those with more limited mobility may be restricted to wheelchairs or electric carts, others with greater mobility may require only a cane or a crutch or crutches.

The classic or conventional cane or crutch essentially comprises a rigid, elongate pole with some form of brace and a handgrip for the user. Canes and underarm crutches have been known for a considerable period of time, and more recently the forearm crutch has been developed. While the forearm crutch uses a semicircular cuff that fits about the upper forearm of the user, both types of crutches include a handgrip for the user as well.

Another point in common between canes and these types of crutches is that they conventionally provide no resilience for the user, other than a relatively small crutch tip at the lower end of the pole. The crutch tip is provided not so much for shock absorption as for frictional grip on the underlying surface. While adjustment is provided for the length of the crutch for users of different heights, the adjustment is locked in place once it is set; no resilience or “give” is provided in the conventional crutch structure. As a result, shock from the impact of the cane or crutch tip against the underlying surface is transferred up the length of the conventional rigid cane or crutch pole to the hand, arm, and shoulder of the user with every crutch swing and step of the user. This is true of both conventional underarm crutches and forearm crutches as well.

Thus, a crutch solving the aforementioned problems is desired.

### SUMMARY OF THE INVENTION

The crutch includes an upper structure with a lower pole or strut extending therefrom. A forearm cuff extension may be installed for use as a forearm crutch, and/or a cane may be used as the lower pole or strut. The heights or lengths of the forearm cuff extension and lower pole extension may be adjusted and locked in place, as desired. A bracket is affixed to the lower pole extension, with a flexible, resilient bow or limb immovably affixed thereto. The upper or attachment end of the limb is essentially stationary relative to the lower pole extension of the crutch, but the lower portion of the limb can compress and flex to some extent when weight is applied to the crutch due to the flexibility of the limb or bow material. The upper end of the limb is preferably axially offset rearwardly of the crutch pole, with the upper portion of the limb curving further rearwardly before recurving forwardly to the lowermost portion thereof. Thus, the axis of the crutch pole extends through the limb or bow at a point through its distal, lowermost or surface contact portion in order to provide a rotational torque or moment in the direction of travel for the user. Resilient padding having a high coefficient of friction may be attached to the bottom of the distal end of the limb to provide good traction and additional resilience. The limb pad may have a lower surface substantially normal to the axis of the lower pole extension of the crutch, if so desired.

The action of the crutch provides a number of benefits when the user's weight is placed upon the crutch. First, the arm or distance between the upper axis and portion of the limb and the axis of the crutch pole results in a rotational torque or moment in the direction of travel of the user, thereby facilitating walking with the crutch. Second, the compression of the limb or bow absorbs the shock that would otherwise be imparted to the user by a rigid crutch. Also, the resilience of the bow or limb urges the crutch upwardly against the weight or pressure of the user, thereby returning a considerable amount of the energy applied to the crutch by the compression of the bow or limb as the upper portion of the crutch rocks forwardly at the end of each swing or stroke. Finally, the limb compression slightly shortens the overall length or height of the crutch as pressure is applied thereto, thereby reducing the vertical travel of the upper end of the crutch as the crutch becomes more aligned with the vertical and as the greatest weight of the user is placed thereon during the middle portion of the swing or stroke.

These and other features of the present invention will become readily apparent upon further review of the following specification and drawings.

### BRIEF DESCRIPTION OF THE DRAWINGS

FIG. 1 is an environmental, perspective view of a pair of forearm crutches according to the present invention, showing their use.

FIG. 2 is an exploded detailed perspective view of the lower limb and attachment assembly of the crutch.

FIG. 3 is a right side elevation view of the forearm crutch of FIG. 1, showing the rearward offset of the upper limb attachment and the rearward curvature of the upper portion of the limb to produce a forward torque or moment when weight or force is applied to the crutch.

FIG. 4 is a right side elevation view showing the progression of the forearm crutch of FIG. 1 through a single step or cycle, showing the action of the crutch during use.

FIG. 5 is a right side elevation view of a prior art forearm crutch showing the progression of the crutch through a series of steps, showing the lack of resilience and varying elevation of the upper end of the prior art crutch during use.

Similar reference characters denote corresponding features consistently throughout the attached drawings.

### DETAILED DESCRIPTION OF THE PREFERRED EMBODIMENTS

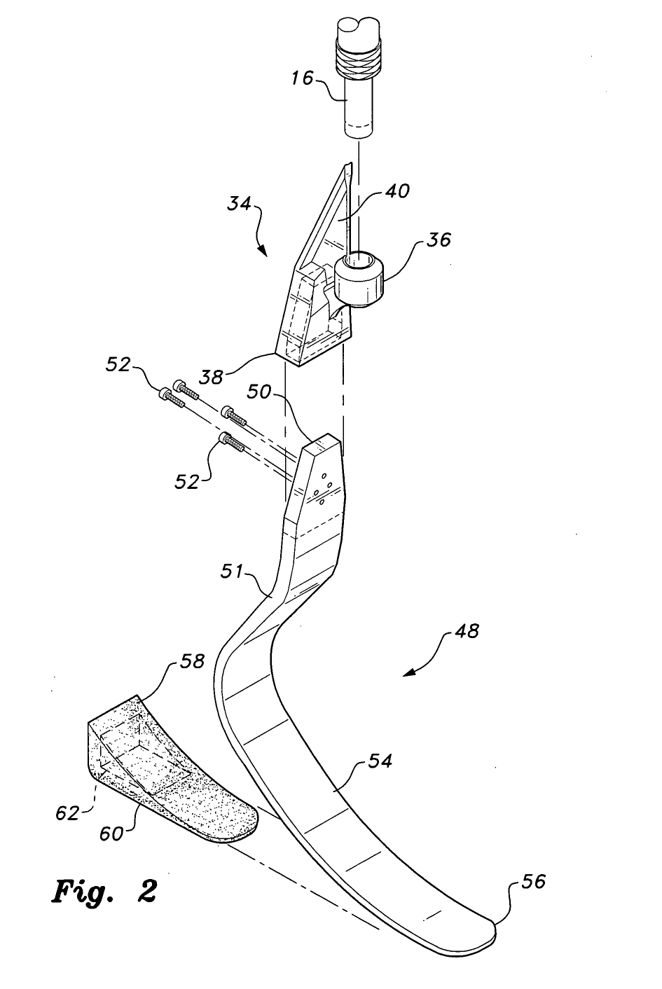

The crutch has a flexible limb or bow extending from the lower end of the pole, serving to absorb shock when the limb contacts the underlying surface and return the energy applied to the limb during compression by rebounding to assist the user of the crutch. The pole is forwardly offset from the upper end of the flexible limb, which results in a forwardly oriented torque or moment when the user applies weight to the crutch. The compression of the flexible limb also results in the upper portion of the crutch compressing downwardly somewhat when weight is applied thereto, thereby reducing the vertical oscillation of the upper end of the crutch as the crutch moves through its cyclic motion during use, thereby facilitating mobility for the user. While a forearm crutch is illustrated in the various drawings, it should be noted that the resilient limb assembly shown in detail in FIG. 2 may be applied to any related type of device, including underarm crutches and canes.

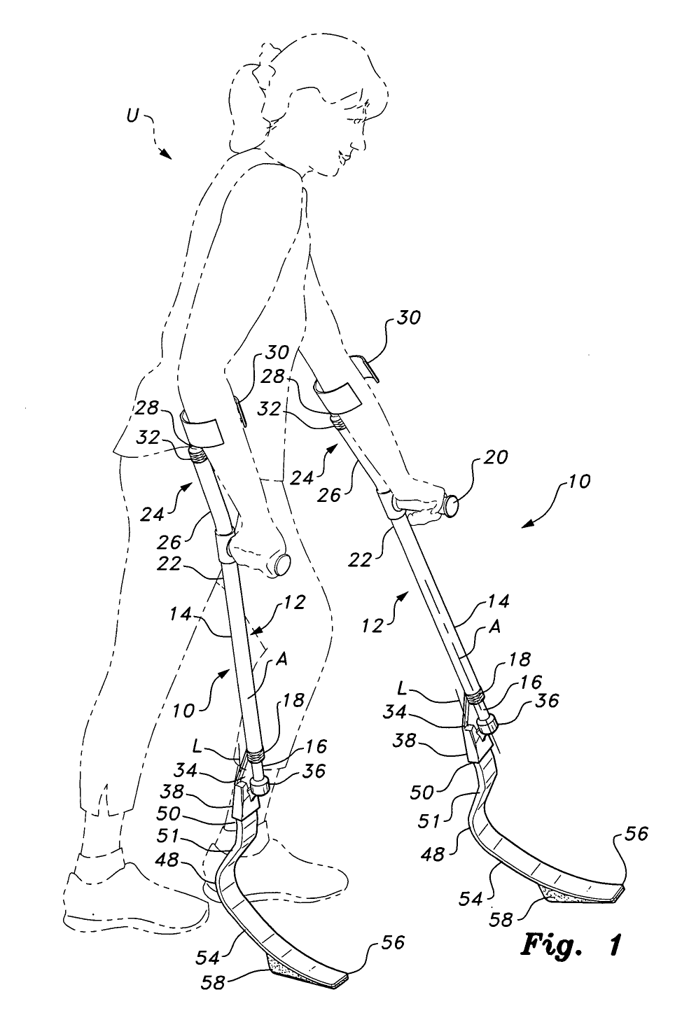

FIG. 1 of the drawings provides an environmental perspective view of a user U using two of the forearm crutches 10. Each crutch 10 includes a lower pole assembly 12 preferably comprising an upper tube 14 with a lower tube 16 telescopically sliding within the upper tube, the assembly 12 defining an elongate lower pole assembly axis A. A conventional friction lock 18 may be installed at the lower end of the upper tube for the user to lock the two tubes 14 and 16 relative to one another to fix their total length as desired. Alternatively, a diametric pin(s) selectively inserted through a pair of holes through the two tubes may be used to fix the total length as desired.

A handgrip 20 extends from the upper end 22 of the upper tube 14, with a forearm cuff support assembly 24 also extending from the upper end 22 of the upper tube 14. The forearm cuff support assembly may also provide adjustment as desired, with the assembly having a lower tube 26 with a smaller diameter forearm cuff attachment tube 28 telescopically sliding within the lower tube. A forearm cuff 30 extends from the upper end of the forearm cuff attachment tube 28. Another friction lock 32 is provided at the upper end of the lower tube 26 to allow adjustment of the combined lengths of the two forearm cuff support assembly tubes 26 and 28 and to lock the combined lengths of the two tubes 26 and 28 as desired.

A limb attachment bracket 34 is immovably affixed to the lower end of the lower tube 16 of the lower pole assembly 12. The bracket 34 includes a forwardly offset crutch pole attachment fitting 36 and a rearwardly offset limb attachment socket 38. The crutch pole attachment fitting 36 is essentially a cylindrical socket into which the lower end or tip of the lower tube 16 is installed, e.g., welded, mechanically attached or adhesively bonded, etc. The majority of the limb attachment socket 38 is laterally tapered to provide a tight fit for the upper or attachment end of the limb or bow, discussed further below. The opposite lateral walls of the limb attachment socket 38 are parallel to one another at their lowermost portions, and fit closely about the uppermost parallel side portions of the limb or bow. A web 40 having its plane in the longitudinal axis, i.e., the fore and aft axis of motion of the crutch when in use, extends between the pole attachment socket or fitting 36 and the limb attachment socket 38, with the web extending a short distance up the lower end of the lower tube 16 and being secured thereto.

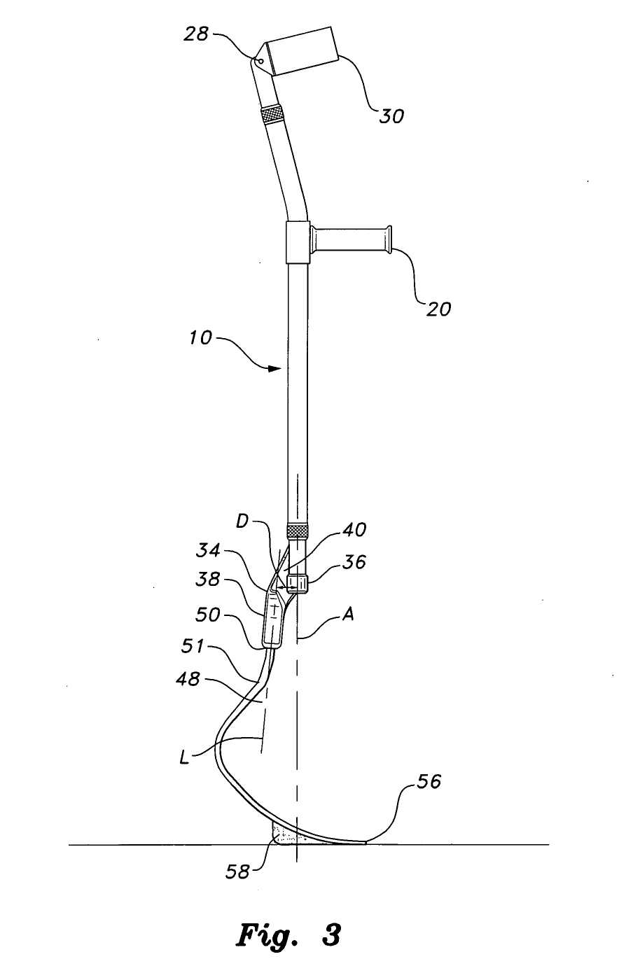

This results in the limb attachment socket 38 being axially offset from the axis A of the lower pole assembly 12, as indicated by the bracket second leg axis L in FIGS. 1 and 3 of the drawings. Preferably this axial offset of the limb attachment socket 38 of the bracket 34 is to the rear of the crutch 10 when the crutch is in its normal disposition for use, generally as shown in FIGS. 1, 3 and 4 of the drawings. The limb attachment socket 38 of the bracket 34 need not be precisely parallel to the axis A of the lower pole assembly 12, but may be angularly offset to intercept the axis A at about the location of the attachment of the handgrip 20 thereto.

An arcuate, flexible, resilient limb 48 has a tapered upper end 50 tightly affixed within the limb attachment socket 38 of the limb attachment bracket 34, e.g., using bolts 52 as shown in FIG. 2, etc. Details of the limb 48 are most clearly shown in FIG. 2 of the drawings, along with the limb attachment bracket 34. The upper portion 51 of the limb 48 extends downwardly and curves rearwardly from the upper or attachment end 50. The limb 48 further has a medial portion 54 curving downwardly and forwardly from the upper portion 51, and a distal lower end 56 opposite the upper end 50 and extending somewhat forwardly thereof and forwardly of the lower pole axis A of the crutch. Although the upper end 50 of the limb or bow 48 is rigidly and immovably affixed to the lower end of the lower tube 16 of the lower pole assembly 12 by means of the bracket 34, the resilient and flexible nature of the limb 48 allows the medial and lower portions 54 and 56, and to a lesser extent the thicker upper portion 51, to flex relative to the upper end 50 and the lower pole assembly 12. This enables the limb 48 to absorb most all of the impact shock resulting from the crutch 10 contacting the underlying surface during use.

The limb 48 may be manufactured of any of a number of different materials, so long as the materials used provide the required flexibility and resilience for the limb. For example, laminated carbon fiber or glass fiber composite material may be used, as these laminated materials provide good strength and resistance to breakage while still providing the necessary flexibility and resilience. Even laminates of various types of wood might be used, if sufficient thickness were provided for the required strength. Alternatively, a homogeneous strong and dense plastic might be used for the limb 48, if so desired. In many cases a flexible and resilient metal such as spring steel or titanium might be used, with titanium being particularly suitable due to its relatively light weight for its strength, although titanium is a relatively costly material compared to others that might be used. Even some alloys of aluminum might be used, depending upon the required load bearing capacity of the crutch and the resilience and flexibility needed.

Preferably, the limb 48 is formed with a gradual taper in thickness from its upper end 50 to its opposite lower or distal end 56, so that its lower or distal end 56 is considerably thinner than its opposite upper or attachment end 50. This is most clearly shown in FIG. 2 of the drawings, but is also shown in FIGS. 1, 3 and 4. This provides the desired rigidity for attaching the upper end 50 to the bracket 34, while still providing the desired flexibility for the remainder of the limb.

A resilient pad 58 is installed beneath the lower end 56 of the limb 48, extending rearwardly beneath the limb toward the medial portion 54 thereof. The pad 58 serves two functions: First, its resilience provides even more cushioning of impact shock for the user of the crutch, in addition to that provided by the flexible limb 48. Secondly, the material of which the pad 58 is formed, e.g., rubber, etc., is of a high coefficient of friction to provide excellent grip and traction for the crutch 10. It will be seen that the pad 58 is not of uniform thickness, but has an upper surface conforming to the curvature of the bow or limb 54 when at rest and a substantially flat lower or bottom surface 60. The bottom surface 60 is essentially normal to the lower crutch pole axis A. This results in the action of the crutch 10 having a feel somewhat like a conventional shoe, with its relatively thicker heel located behind the thinner and more flexible forward portion of the sole of the shoe. Greater resilience may be provided for the pad 58 by forming it with a sealed hollow interior 62, i.e., providing a pneumatic pad, as shown in FIG. 2 of the drawings.

FIG. 3 of the drawings clearly shows the rearward offset of the upper end of the limb 48 relative to the crutch pole axis A, as well as the rearward curvature of the upper portion 51 of the limb. Due to the offset between the crutch pole attachment fitting 36 and the limb attachment socket 38 of the limb attachment bracket 34, the upper or attachment end 50 of the limb 48 is displaced rearwardly from the crutch lower pole axis A by a distance D. This results in the downward extension of the axis A intersecting the underlying surface close to the heel of the resilient pad 58, and well back from the lower or distal end 56 of the limb. The downwardly diverging angle between the crutch pole axis A and the plane of the upper end 50 of the limb 48 also provides some additional offset at the lower or distal portion of the limb. The result of this rearward offset distance D of the limb attachment relative to the crutch pole axis A is a torque or moment when weight or generally downward force is applied to the crutch pole. It will be seen that the weight or force is applied to the resilient limb through the rearward offset distance D, thereby resulting in a moment or torque in the opposite or forward direction, i.e., clockwise in the right side views shown in the various drawings. As the bottom of the crutch 10 is momentarily fixed to the underlying surface due to the friction of the resilient pad 58, this tends to rock the upper portion of the crutch forward, thereby assisting the user as he or she moves forwardly with the crutch.

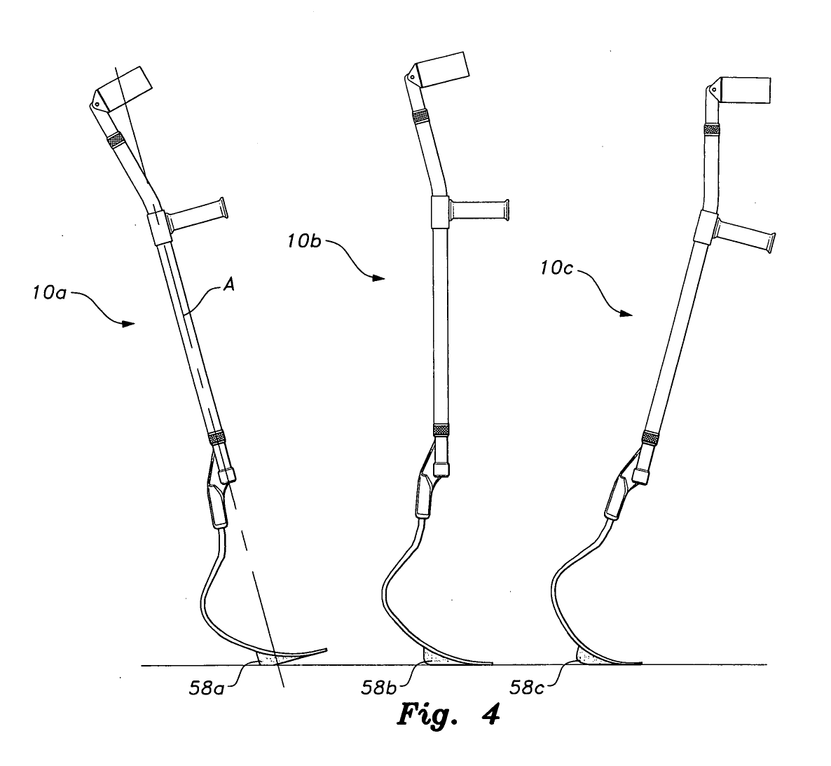

FIG. 4 of the drawings illustrates the action of the crutch through a cycle, showing how the upper portion of the crutch rotates forwardly as the user walks with the crutch. It should be understood that the base of the crutch, i.e., the resilient pad 58, would remain in one location on the underlying surface during such a cycle, with the lower end of the crutch then being lifted and swung forward to repeat the cycle for each step. The three positions of the crutch are indicated as crutch 10a, 10b, and 10c in FIG. 4.

Initially, the lower end of the crutch is swung forwardly to place the resilient pad ahead of the user, generally as shown in the left crutch 10a position in FIG. 4 and in the position of the left side crutch 10 in FIG. 1. It will be seen that the axis A of the crutch 10a intersects the supporting surface slightly ahead of the contact point of the heel of the resilient pad 58a due to the rearward offset of the limb attachment relative to the crutch axis A, as shown in FIG. 3 and explained further above, and the rearward bend or curvature of the upper portion 51 of the limb. The torque or moment produced as weight or force is applied along the crutch pole axis A results in the crutch tending to rock forwardly, thus assisting the user of the crutch during the initial portion of the cycle.

As the user continues to move forward, the upper portion of the crutch will swing forwardly through an arc above the lower limb, or more specifically, above the rest point of the pad upon the lower surface, as shown generally by the position of the crutch 10b in FIG. 4. In the case of a conventional rigid crutch, the user must impart a forward force to overcome the rearward angle of the upper portion of the crutch between crutch angles 10a and 10b in FIG. 4. The upper end of the conventional crutch also rises as the crutch passes from its initial angled position to the vertical, thus requiring further energy from the user as the upper portion of his or her body must “climb” the slope as the upper end of the crutch rises. In the case of the crutch 10 with its resilient limb 48, the limb 48 compresses to some extent to at least partially alleviate this problem of the upward rise of the upper portion of the crutch as it rocks or pivots to the vertical position, shown as crutch 10b in FIG. 4.

The crutch continues to rock or pivot forwardly from the crutch position 10b to the crutch position 10c, as the user continues to move forward. As the crutch rocks forwardly, the weight of the user is gradually removed therefrom until the crutch may be lifted from the underlying surface and swung forward to repeat the cycle. However, the weight remaining on the crutch is applied more toward the forward (thinner) distal end of the resilient limb 48, resulting in some flexing or bending of this portion of the limb 48. The springback of the lower limb as the weight of the user is removed from the crutch 10c, results in some forward impetus to the user due to the forwardly angled upper portion of the crutch 10 at this point in the cycle. This has the additional effect of slightly raising the upper end of the crutch 10 to counter the geometric effect of the upper end lowering through a sinusoidal arc, thereby somewhat reducing the downward vector of the upper portion of the crutch as it travels from the vertical orientation of crutch 10b to the forwardly oriented position of crutch 10c.

The net result is that the crutch 10 delivers some slight forward thrust to the user as the lower limb 48 extends at the end of each cycle. Also, the upper body of the user is not subjected to a series of relatively large rising and falling motions due to the angle of the crutch 10 changing periodically with each cycle, to the extent produced by a conventional rigid crutch. Thus, the forearm crutch 10 greatly reduces the workload and increases the endurance of the user in comparison to conventional rigid crutches and other crutches having resilient means.

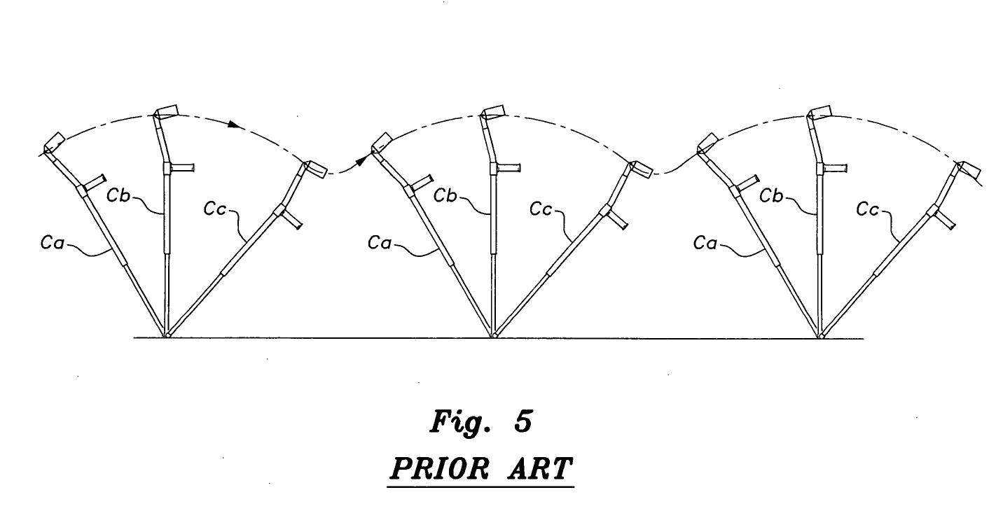

Prior art FIG. 5 illustrates the cyclic sequence of use of a conventional rigid forearm crutch, with the three different positions designated as crutch Ca, Cb, and Cc in the repetitive three sequences in FIG. 5. The lack of any resilience and offset to assist the user is evident. Further, as the length of the rigid crutch Ca, Cb, Cc does not change, it will be seen in FIG. 5 that the upper end of the crutch rises and falls as a function of the sine of the angle between the crutch and the underlying surface. The result is a sinusoidal path for the upper end of the crutch, when the user is traveling over a relatively level surface. This is quite taxing to the user of such a conventional rigid crutch, as he or she must raise his or her weight upwardly as the crutch swings from an acute angle to normal with the underlying surface, only to drop downwardly as the crutch swings past the vertical. The cycle is then repeated with each step the user takes, resulting in a tiring series of up and down cycles for the user of such a conventional forearm crutch.

It is to be understood that the present invention is not limited to the embodiments described above, but encompasses any and all embodiments within the scope of the following claims.

I claim:

1. A crutch, comprising:
a lower pole assembly having an upper end and a lower end opposite the upper end, the lower pole assembly defining a lower pole assembly axis;
a handgrip extending from the upper end of the lower pole assembly; and
an arcuate, flexible, resilient limb having an upper end, a lower end opposite the upper end, a medial portion therebetween, and an upper portion between the upper end and the medial portion, the upper end being rigidly and immovably affixed to the lower end of the lower pole assembly, the upper portion curving rearwardly from the upper end, the medial portion curving downwardly and forwardly from the upper portion to the lower end.

2. The crutch according to claim 1, further comprising a limb attachment bracket having:
a forwardly offset crutch pole attachment fitting affixed to the lower end of the lower pole assembly;
a rearwardly and angularly offset limb attachment socket; and
a web extending between the fitting and the socket, the upper end of the limb being affixed within the limb attachment socket of the limb attachment bracket and axially offset from the lower pole assembly by the web.

3. The crutch according to claim 1, further comprising a resilient pad disposed beneath the limb, the pad having a flat bottom surface having a high coefficient of friction, the pad extending substantially normal to the lower pole assembly.

4. The crutch according to claim 3, wherein the pad has a sealed, hollow, pneumatic interior.

5. The crutch according to claim 1, wherein the lower pole comprises an upper tube and a lower tube telescopically disposed within the upper tube and a friction lock disposed upon the lower pole assembly, selectively locking the upper tube and the lower tube of the lower pole assembly at an adjustable length, the crutch further comprising;
a forearm cuff support assembly extending from the upper end of the lower pole assembly, the forearm cuff support assembly having a lower end joining the upper end of the lower pole assembly and an upper end opposite the lower end;
a forearm cuff extending from the upper end of the forearm cuff support assembly, the forearm cuff support assembly having a lower tube and an upper tube telescopically disposed within the lower tube; and
a friction lock disposed upon the forearm cuff support assembly, the friction lock selectively locking the lower cuff support assembly tube and the upper cuff support assembly tube at an adjustable length.

6. The crutch according to claim 1, wherein the limb has a gradually tapering thickness from the upper end to the lower end, the upper end of the limb having a greater thickness than the lower end of the limb.

7. The crutch according to claim 1, wherein the limb is formed of at least one material selected from the group consisting of glass fiber composite, carbon fiber composite, plastic, laminated wood, steel, titanium, and aluminum.

8. A crutch, comprising:
a lower pole assembly having an upper end and a lower end opposite the upper end, the lower pole assembly defining a lower pole assembly axis;
a handgrip extending from the upper end of the lower pole assembly;
a limb attachment bracket having a forwardly offset crutch pole attachment fitting affixed to the lower end of the lower pole assembly, a rearwardly and angularly offset limb attachment socket, and a web extending between the fitting and the socket; and
an arcuate, flexible, resilient limb having an upper end rigidly and immovably affixed to the limb attachment socket, a lower end opposite the upper end, a medial portion therebetween, and an upper portion between the upper end and the medial portion, the upper end of the limb being axially offset from the lower pole assembly.

9. The crutch according to claim 8, wherein the upper portion curves rearwardly from the upper end and the medial portion curves downwardly and forwardly from the upper portion to the lower end.

10. The crutch according to claim 8, further comprising a resilient pad disposed beneath the limb, the pad having a flat bottom surface, the bottom surface having a high coefficient of friction, the pad extending substantially normal to the lower pole assembly.

11. The crutch according to claim 10, wherein the pad has a sealed, hollow, pneumatic interior.

12. The crutch according to claim 8, wherein the lower pole comprises an upper tube and a lower tube telescopically disposed within the upper tube and a friction lock disposed upon the lower pole assembly, selectively locking the upper tube and the lower tube of the lower pole assembly at an adjustable length, the crutch further comprising;
a forearm cuff support assembly extending from the upper end of the lower pole assembly, the forearm cuff support assembly having a lower end joining the upper end of the lower pole assembly and an upper end opposite the lower end;
a forearm cuff extending from the upper end of the forearm cuff support assembly, the forearm cuff support assembly having a lower tube and an upper tube telescopically disposed within the lower tube; and
a friction lock disposed upon the forearm cuff support assembly, the friction lock selectively locking the lower cuff support assembly tube and the upper cuff support assembly tube at an adjustable length.

13. The crutch according to claim 8, wherein the limb has a gradually tapering thickness from the upper end to the lower end, the upper end of the limb having a greater thickness than the lower end of the limb.

14. The crutch according to claim 8, wherein the limb is formed of at least one material selected from the group consisting of glass fiber composite, carbon fiber composite, plastic, laminated wood, steel, titanium, and aluminum.

15. A crutch, comprising:
a lower pole assembly having an upper end and a lower end opposite the upper end, the lower pole assembly defining a lower pole assembly axis;
a handgrip extending from the upper end of the lower pole assembly;
an arcuate limb having an upper end, a lower end opposite the upper end, a medial portion therebetween, and an upper portion between the upper end and the medial portion, the upper end being rigidly and immovably affixed to the lower end of the lower pole assembly, the upper portion curving rearwardly from the upper end, the medial portion curving downwardly and forwardly from the upper portion to the lower end; and
a resilient pad disposed beneath the limb, the pad having a flat bottom surface, the flat bottom surface having a high coefficient of friction, the pad extending substantially normal to the lower pole assembly.

16. The crutch according to claim 15, further comprising a limb attachment bracket having:
a forwardly offset crutch pole attachment fitting affixed to the lower end of the lower pole assembly;
a rearwardly and angularly offset limb attachment socket; and
a web extending between the fitting and the socket, the upper end of the limb being affixed within the limb attachment socket of the limb attachment bracket and axially offset from the lower pole assembly by the web.

17. The crutch according to claim 15, wherein the pad has a sealed, hollow, pneumatic interior.

18. The crutch according to claim 15, wherein the lower pole comprises an upper tube and a lower tube telescopically disposed within the upper tube and a friction lock disposed upon the lower pole assembly, selectively locking the upper tube and the lower tube of the lower pole assembly at an adjustable length, the crutch further comprising;
a forearm cuff support assembly extending from the upper end of the lower pole assembly, the forearm cuff support assembly having a lower end joining the upper end of the lower pole assembly and an upper end opposite the lower end;
a forearm cuff extending from the upper end of the forearm cuff support assembly, the forearm cuff support assembly having a lower tube and an upper tube telescopically disposed within the lower tube; and
a friction lock disposed upon the forearm cuff support assembly, the friction lock selectively locking the lower cuff support assembly tube and the upper cuff support assembly tube at an adjustable length.

19. The crutch according to claim 15, wherein the limb has a gradually tapering thickness from the upper end to the lower end, the upper end of the limb having a greater thickness than the lower end of the limb.

20. The crutch according to claim 15, wherein the limb is formed of at least one material selected from the group consisting of glass fiber composite, carbon fiber composite, plastic, laminated wood, steel, titanium, and aluminum.
